(19) United States
(12) Patent Application Publication
(10) Pub. No.: US 2015/0220036 A1
(43) Pub. Date: Aug. 6, 2015

(54) IMAGE FORMING APPARATUS

(71) Applicant: BROTHER KOGYO KABUSHIKI KAISHA, Nagoya (JP)

(72) Inventor: Hirotaka MORI, Nagoya (JP)

(21) Appl. No.: 14/607,494

(22) Filed: Jan. 28, 2015

(30) Foreign Application Priority Data
Jan. 31, 2014 (JP) 2014-017474

(51) Int. Cl. G03G 15/00

(52) U.S. Cl. CPC G03G 15/6529

(57) ABSTRACT

An image forming apparatus, including a conveyer, an image forming unit, and paired bearings, is provided. The conveyer unit includes a first roller, a second roller, and a belt strained around the first and second rollers. The belt includes a first surface to contact the sheet. The image forming unit forms an image on the sheet being conveyed in an image forming area. The image forming area has a width which is larger than a width of the belt along a direction of rotation axis of the first and second rollers. The paired bearings support the first roller rotatably. The paired bearings are arranged on both sides of the belt with regard to the direction of rotation axis. A distance between the paired bearings is shorter than the width of the image forming area.

### CROSS REFERENCE TO RELATED APPLICATION

This application claims priority from Japanese Patent Application No. 2014-017474, filed on Jan. 31, 2014, the entire subject matter of which is incorporated herein by reference.

### Background

1. Technical Field

An aspect of the present disclosure relates to a technique to convey a sheet by rolling a belt in an image forming apparatus.

2. Related Art

An image forming apparatus, in which a belt is rolled to convey a sheet, and an image is formed on the sheet being conveyed, is known. The belt in the image forming apparatus may be strained around two (2) or more rollers so that the sheet is conveyed on the belt as the rollers rotate and an image is formed on the sheet being conveyed. In order to reduce a manufacturing cost for the image forming apparatus, the belt may be designed to have a width, which is a dimension along rotation axes of the rollers, to be smaller than a width of a photo-exposable area of a photosensitive drum. Meanwhile, paired bearings to support the rollers may be arranged on outer sides of the width of the photo-exposable area of the photosensitive drum.

### SUMMARY

Thus, if the paired bearings to support the rollers are arranged on the outer sides of the width of the photo-exposable area of the photosensitive drum, a distance between the paired bearings along a direction of rotation axes of the rollers may be larger than the width of the photo-exposable area of the photosensitive drum. Therefore, a distance between at least one of the paired bearings and the belt along the direction of rotation axes may be longer, and the rollers extending along the longer distance may be deformed by tensile force of the strained belt.

The present disclosure is advantageous in that a technique to restrain deformation of the rollers is provided.

According to an aspect of the present disclosure, an image forming apparatus, including a conveyer, an image forming unit, and paired bearings, is provided. The conveyer unit includes a first roller, a second roller, and a belt strained around the first roller and the second roller. The belt includes a first surface configured to contact the sheet. The image forming unit is configured to form an image on the sheet being conveyed in an image forming area. The image forming area has a width being larger than a width of the belt along a direction of rotation axis of the first roller. The paired bearings are configured to support the first roller rotatably. The paired bearings are arranged on both sides of the belt with regard to the direction of rotation axis. A distance between the paired bearings is shorter than the width of the image forming area.

### BRIEF DESCRIPTION OF THE ACCOMPANYING DRAWINGS

FIG. 1 is an illustrative view of a mechanical configuration of a printer according to an exemplary embodiment of the present disclosure.

FIG. 2 is a block diagram to illustrate electrical configuration of the printer according to the exemplary embodiment of the present disclosure.

FIG. 3 is a perspective view of a belt unit of the printer according to the exemplary embodiment of the present disclosure.

FIG. 4 is an illustrative top plan view of a support roller in the belt unit of the printer according to the exemplary embodiment of the present disclosure.

FIG. 5 is an illustrative side view of a driving roller in the belt unit of the printer according to the exemplary embodiment of the present disclosure.

FIG. 6 is an illustrative perspective view of the belt unit of the printer according to an exemplary embodiment of the present disclosure.

### DETAILED DESCRIPTION

Hereinafter, a printer 1 as an exemplary embodiment of the present disclosure will be described with reference to the accompanying drawings. It is noted that various connections are set forth between elements in the following description. These connections in general, and unless specified otherwise, may be direct or indirect, and this specification is not intended to be limiting in this respect.

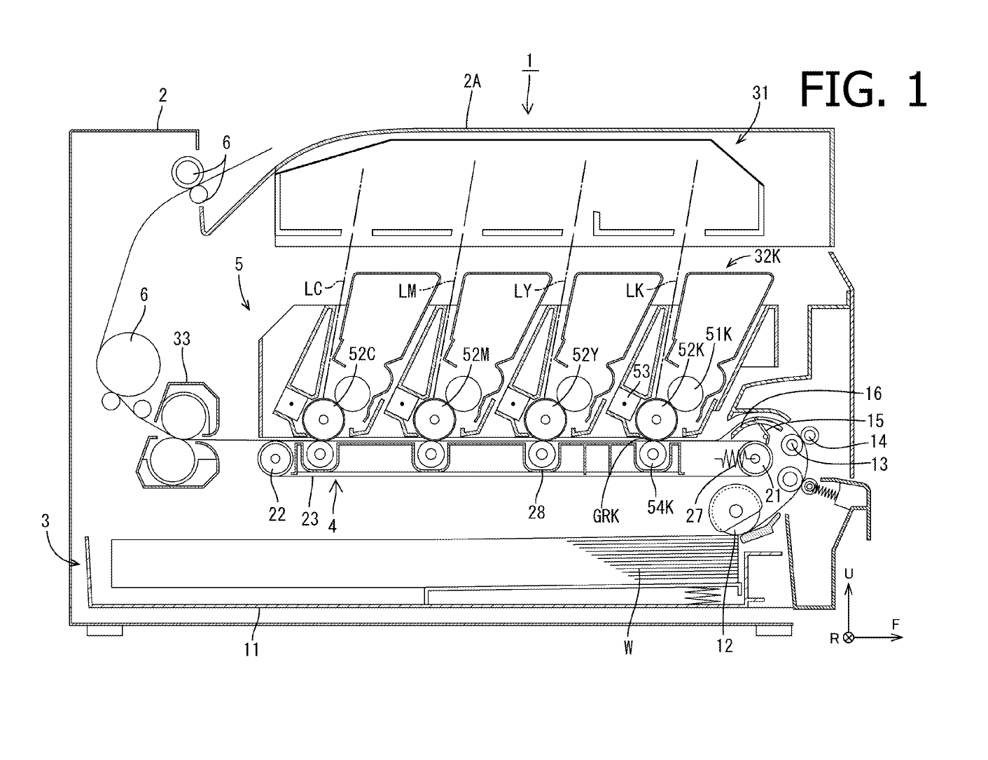

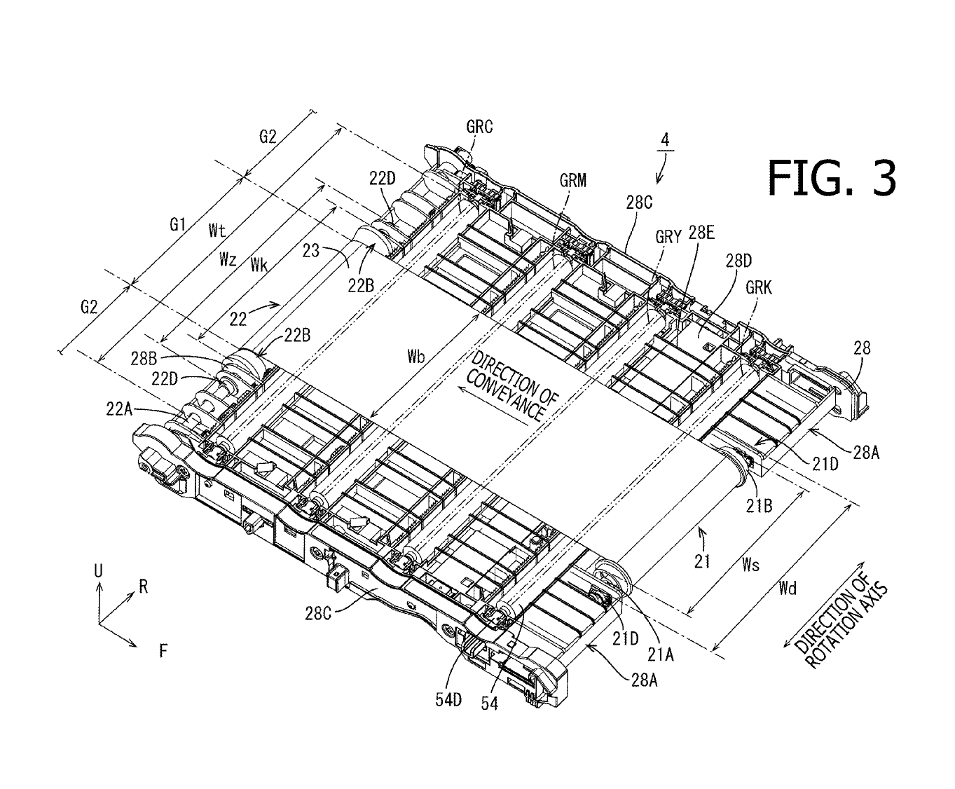

The printer 1 is a direct-transferring tandem-typed color laser printer capable of forming images in a plurality of (e.g., four) colors, which are, for example, black (K), yellow (Y), magenta (M), and cyan (C). In the following description, directions concerning the printer 1 and each part or component included in the printer 1 will be referred to based on orientations indicated by arrows shown in each drawing. For example, a viewer's right-hand side in FIG. 1 is defined as a front side F, and a left-hand side is defined as rear. A viewer's farther side in FIG. 1 is defined as a right-hand side R of the printer 1, and a nearer side is defined as a left-hand side. An upper side in FIG. 1 corresponds to an upper side U of the printer 1 according to a direction of gravity. A right-to-left or left-to-right direction of the printer 1 may also be referred to as a right-left direction or a widthwise direction. An up-to-down or down-to-up direction with regard to the direction of gravity may also be referred to as a vertical direction. A front-to-rear or rear-to-front direction may be referred to as a front-rear direction or a direction of depth. Furthermore, directions of the drawings in FIGS. 3-6 are similarly based on the orientation of the printer 1 as defined above and correspond to those with respect to the printer 1 shown in FIG. 1 even when the printer 1 in the drawings is viewed from different angles. However, the orientations concerning the printer 1 may not necessarily be limited to those described below or indicated in the accompanying drawings. Further, it is noted that a quantity of each of the components and elements denoted by reference signs is, unless otherwise noted, at least one.

In the printer 1 according to the present disclosure, there may be a plurality of parts or components which are in an identical configuration for forming images in the plurality of colors K, Y, M, C. Those identically-configured parts or components may be indicated by the same reference signs except for letters (K, Y, M, C) at the ends thereof, which indicate the different colors. Meanwhile, the reference sigs without the letters (K, Y, M, C) at the ends may be used to represent the plurality of identically-configured parts or components. In the accompanying drawings, reference signs for some of the parts or components in the identical configuration may be omitted.

The printer 1 includes a main casing 2, a sheet feeder unit 3, a belt unit 4, an image forming unit 5, and ejection rollers 6.

The sheet feeder unit 3 includes a feeder tray 11, a pickup roller 12, a registration roller 13, a pinch roller 14, a sheet guide 16, and a sheet sensor 15. The pickup roller 12 forwards sheets W stored in the feeder tray 11 one-by-one to the registration roller 13 and the pinch roller 14.

The registration roller 13 rotates to convey the sheet W to the belt unit 4, which will be described later in detail. The pinch roller 14 is rotated according to the rotation of the registration roller 13 and conveys the sheet W in conjunction with the registration roller 13. The sheet guide 16 is arranged to contact the sheet W being conveyed by the registration roller 13 and the pinch roller 14 and guide the sheet W to the belt unit 4.

The sheet sensor 15 is arranged to detect presence of the sheet W in a detectable area, which is between the registration roller 13 and the belt unit 4, and outputs signals according to detected presence or absence of the sheet W in the detectable area. Based on the signals, which indicate detection of a leading edge of the sheet W in the detectable area, from the sheet sensor 15, a timing to form an image on the sheet W is determined

The belt unit 4 includes a support roller 21, a driving roller 22, a belt 23 being an endless belt, and a resilient member 27, which are supported by a frame 28. The belt 23 is strained around the support roller 21 and the driving roller 22 and is rolled to circulate in a counterclockwise direction in FIG. 1 to convey the sheet W being contacted with an upper outer surface of the belt 23 toward the rear side.

The resilient member 27 is arranged to resiliently urge the support roller 21 in a direction to be away from the driving roller 22. Thus, due to the resiliency of the resilient member 27, the support roller 21 serves to apply tensile force to the belt 23 so that the belt 23 is restricted from loosening between the driving roller 22 and the support roller 21. In other words, the support roller 21 and the driving roller 22 are affected by the tensile force caused in the belt 23. On an inner side of the belt 23, arranged are transfer rollers 54. The transfer roller 54 includes a transfer roller 54K for black, a transfer roller 54Y for yellow, a transfer roller 54M for magenta, and a transfer roller 54C for cyan.

The image forming unit 5 includes a scanner unit 31, processing units 32K, 32Y, 32M, 32C, and a fixing unit 33.

The scanner unit 31 emits laser beams LK, LY, LM, LC according to image data for the four colors onto surfaces of photosensitive drums 52K, 52Y, 52M, 52C, which are arranged outside of the belt 23. Thus, the surfaces of the photosensitive drums 52K, 52Y, 52M, 52C are selectively exposed to the laser beams LK, LY, LM, LC respectively.

The processing unit 32K is for forming an image in black and includes a developer roller 51K, a photosensitive drum 52K, a charger 53, and the transfer roller 54K. The developer roller 51K, the photosensitive drum 52K, and the charger 53 are arranged outside of the belt 23, and the transfer roller 54K is arranged on the inner side of the belt 23. The developer roller 51K supplies a black toner to the photosensitive drum 52K.

The surface of the photosensitive drum 52K is electrically charged evenly by the charger 53, and the charged surface of the photosensitive drum 52K is selectively exposed to the laser beam LK from the scanner unit 31. Thus, the exposed area forms an electrostatic latent image. Thereafter, the toner is supplied to the electrostatic latent image by the developer roller 51K so that a toner image in black is developed on the photosensitive drum 52K.

The toner image developed on the photosensitive drum 52K is transferred by static electricity in the transfer roller 54K onto the sheet W being conveyed on the belt 23. Thus, the image is formed in the black toner on the sheet W. In the following description, an area, in which the toner image can be transferred to the sheet W, will be referred to as an image forming area GR. The image forming area GR include an image forming area GRK for black, an image forming area GRY for yellow, an image forming area GRM for magenta, and an image forming area GRC for yellow (see FIG. 3). In this regard, the processing units 32Y, 32M, 32C for yellow, magenta, cyan are in the similar configuration as the processing unit 32K for black; therefore, description of those are herein omitted.

The fixing unit 33 thermally fixes the toner image transferred onto the sheet W thereat. The sheet W conveyed through the fixing unit 33 is conveyed upward by the ejection rollers 6 and ejected on an ejection tray 2A, which is arranged at a top of the main casing 2.

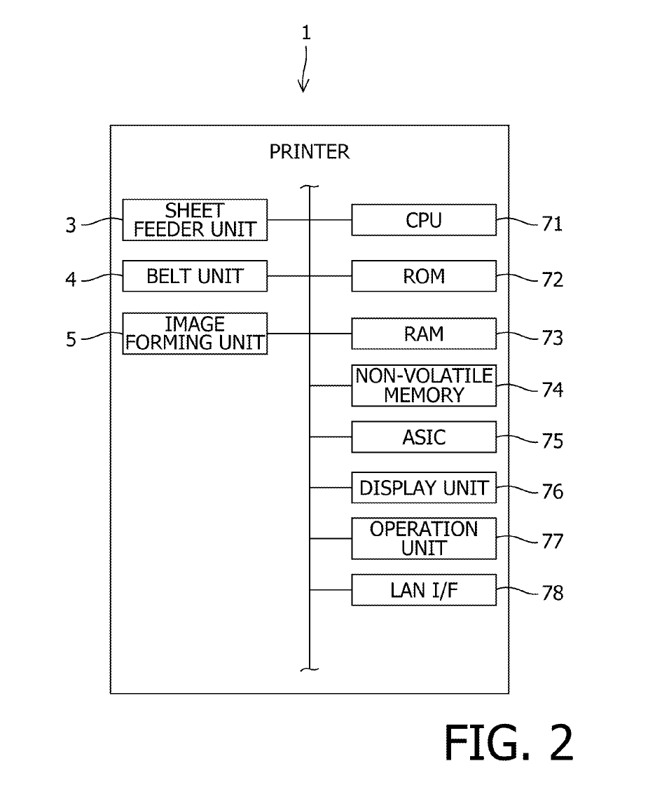

Further to the sheet feeder unit 3, the belt unit 4 and the image forming unit 5 described above, the printer 1 includes, as shown in FIG. 2, a central processing unit (CPU) 71, a read-only memory (ROM) 72, a random access memory (RAM) 73, a non-volatile memory 74, an application specific integrated circuit (ASIC) 75, a display unit 76, an operation unit 77, and a network interface 78.

The ROM 72 stores a various types of programs including a program to control rotation of rollers such as the driving roller 22 in the belt unit 4 and the registration roller 13. The RAM 73 and the non-volatile memory 74 provide work areas for the programs when the programs are running and temporary storages for data being used in the programs. The non-volatile memory 74 may be a writable memory device including an NVRAM, a flash memory, an HDD, an EEPROM.

The CPU 71 is connected with various components in the printer 1, including the ROM 72 and the RAM 73, and controls the components according to the programs read from the ROM 72. The display unit 76 includes a liquid crystal display and lamps (not shown) and is capable of displaying information concerning settings, behaviors of the printer 1, and processes executed in the printer 1, through various forms of screens. The operation unit 77 includes a plurality of buttons (not shown) and is capable of receiving various types of inputs and instructions from a user. The network interface 78 is an interface, through which communication between the printer 1 and an external device (not shown) is exchanged in wireless or wired communication.

Next, with reference to FIGS. 3-5, a detailed configuration of the belt unit 4 is described below. The frame 28 of the belt unit 4 supports bearings 21D, 22D, 54D of the support roller 21, the driving roller 22, and the transfer rollers 54 respectively; thereby, the support roller 21, the driving roller 22, and the transfer rollers 54 are supported in an arrangement such that directions of rotation axes thereof are in parallel with one another, and the support roller 21, the driving roller 22, and the transfer rollers 54 are restricted from moving with respect to one another. In the following description, a direction in parallel with the rotation axes of the support roller 21, the driving roller 22, and the transfer rollers 54 will be referred to as a direction of rotation axis.

The bearings 21D, 22D, 54D are pairs of bearings which rotatably support the support roller 21, the driving roller 22, and the transfer rollers 54 respectively, and are arranged on both sides of the support roller 21, the driving roller 22, and the transfer rollers 54 respectively along the direction of rotation axis. In other words, one and the other one of the paired bearings 21D are arranged on a rightward end and a leftward end of the support roller 21 respectively, one and the other one of the paired bearings 22D are arranged on a rightward end and a leftward end of the support roller 21 respectively, and one and the other one of the paired bearings 54D are arranged on a rightward end and a leftward end of the transfer roller 54 respectively. In this regard, the direction of rotation axis coincide with the widthwise direction of the printer 1 according to the exemplary embodiment. The frame 28 includes a pair of main parts 28C, which longitudinally extend along a direction of conveyance to convey the sheet W, to support the bearings 54D. The frame 28 further includes intermediate parts 28D, which connect the paired main parts 28C with each other along the direction of rotation axis. The intermediate parts 28D are arranged in positions between the transfer rollers 54.

A width Wb, which is a dimension of the belt 23 along the direction of rotation axis, is smaller than a width Wt of the transfer rollers 54 along the direction of rotation axis. In this regard, a maximum allowable dimension of the image forming area GR along the direction of rotation axis in each of the processing units 32K-32C is limited by the width Wt of the transfer rollers 54 along the direction of rotation axis. In other words, the width Wb of the belt 23 along the direction of rotation axis is set to be smaller than the dimension of the image forming area GR along the direction of rotation axis.

Therefore, each transfer roller 54 is in an arrangement with regard to the direction of rotation axis such that a part of the transfer roller 54 is in an overlapping area G1, in which the transfer roller 54 coincides with the upper outer surface of the belt 23 along the direction of rotation axis, and a remainder part of the transfer roller 54 is in an exposed area G2, in which the transfer roller 54 is displaced from the upper outer surface of the belt 23 along the direction of rotation axis. In this regard, the arrangement that the transfer roller 54 coincides with the belt 23 along the direction of rotation axis refers to a condition that the transfer roller 54 and the belt 23 fall on a same area with regard to the direction of rotation axis. In other words, the transfer roller 54 overlaps the belt 23 in a view along a direction orthogonal to the direction of rotation axis, which is, according to the exemplary embodiment, the direction of gravity. Meanwhile, the arrangement that the transfer roller 54 is displaced from the belt 23 refers to a condition that the transfer roller 54 and the belt 23 do not overlap each other in a view along the direction orthogonal to the direction of rotation axis.

The transfer rollers 54K-54C are opposed to the photosensitive drums 52K-52C respectively, across the belt 23 in the overlapping area G1, and directly in the exposed area G2. In other words, in the overlapping area G1, the belt 23 contacts the photosensitive drums 52K-52C, while in the exposed area G2 the transfer rollers 54K-54C contact the photosensitive drums 52K-52C respectively. Meanwhile, the intermediate parts 28D coincident with the exposed area G2 include ribs 28D, which extend along the direction of conveyance to guide the sheet W.

In the exemplary embodiment, the belt 23 and the transfer rollers 54 are in an arrangement such that a center of the belt 23 along the direction of rotation axis is aligned with centers of the transfer rollers 54 along the direction of rotation axis. Therefore, at each side of the belt 23 along the direction of rotation axis, the exposed area G2 exists. In other words, two (2) exposed areas G2 are arranged on outer sides of the overlapping area G1 along the direction of rotation axis.

The support roller 21 is formed in a hollow cylindrical shape and has spokes (unsigned) expanding in radial directions at axial ends thereof The support roller 21 is held via the spokes in a position to be centered at a rotation shaft 21A. In this regard, the support roller 21 is formed separately from the rotation shaft 21A and rotates idly with respect to the rotation shaft 21A.

The driving roller 22 is formed in a hollow cylindrical shape and has spokes (not shown) expanding in radial directions at axial ends thereof The driving roller 22 is held via the spokes in a position to be centered about a rotation shaft 22A. In this regard, the driving roller 22 is fixed to the rotation shaft 22 A and rotates integrally with the rotation shaft 22A.

The driving roller 22 is rotated by a driving force from a motor (not shown), which is activated by an instruction from the CPU 71, and applies a circulating force to the belt 23. The support roller 21 is arranged on an upstream side of the driving roller 22 with regard to a direction of conveyance to convey the sheet W and is rotated by the circulation of the belt 23.

While the belt 23 is strained around the support roller 21 and the driving roller 22, a dimension Ws of the support roller 21 and a dimension Wk of the driving roller 22 along the direction of rotation axis should at least as large as or substantially larger than the width Wb of the belt 23 along the direction of rotation axis. While the width Wb of the belt 23 along the direction of rotation axis is smaller than the width Wt of the transfer rollers 54, therefore, the dimensions Ws, Wk of the support roller 21 and the driving roller 22 are smaller than the dimension Wt of the transfer rollers 54 along the direction of rotation axis and substantially larger than the width Wb of the belt 23 along the direction of rotation axis.

The support roller 21 is provided with a flange part 21B. The flange part 21B includes a pair of flange parts 21B, each of which is formed to protrude outward along a radial direction with respect to a part of the support roller 21 contacting the belt 23. The flange part 21B is arranged in each exposed area G2, which is on an outer side of the belt 23 along the direction of rotation axis. The flange part 21B is arranged to face with a cross-sectional edge of the belt 23, which is at widthwise end along the direction of rotation axis, and restrict the belt 23 from moving in the direction of rotation axis.

The flange part 21B is arranged to protrude outward in the radial direction of the support roller 21 from the upper outer surface of the belt 23. In the exemplary embodiment, as shown in FIG. 1, the sheet guide 16, which forms a part of a conveying path to convey the sheet W therein toward the belt 23, is arranged on a downstream side of the support roller 21 with regard to the direction of conveyance to face with the belt 23 at a position on an upstream side of the image forming area GR with regard to the direction of conveyance. Therefore, while the flange part 21B protrudes from the upper outer surface of the belt 23, the sheet W having been conveyed to the belt 23 may be prevented from contacting the protruding flange part 21B and from being skewed with respect to the direction of conveyance by the contact.

Meanwhile, each of the paired bearings 21D for the support roller 21 is arranged in the exposed area G2, which is provided on each side of the overlapping area G1 with regard to the direction of rotation axis. The bearings 21D are arranged in positions closer to the belt 23 than axial ends of the transfer rollers 54 with regard to the direction of rotation axis. More specifically, the frame 28 includes a stretched part 28A stretching inward toward the belt 23 along the direction of rotation axis from the main parts 28C, which are at axial ends of the transfer rollers 54, and the bearings 21D are supported by the frame 28 at the stretched part 28A. Therefore, a distance Wd between the paired bearings 21D along the direction of rotation axis is shorter than the dimension Wt of the transfer rollers 54 along the direction of rotation axis. The stretched part 28A connects the paired main parts 28C.

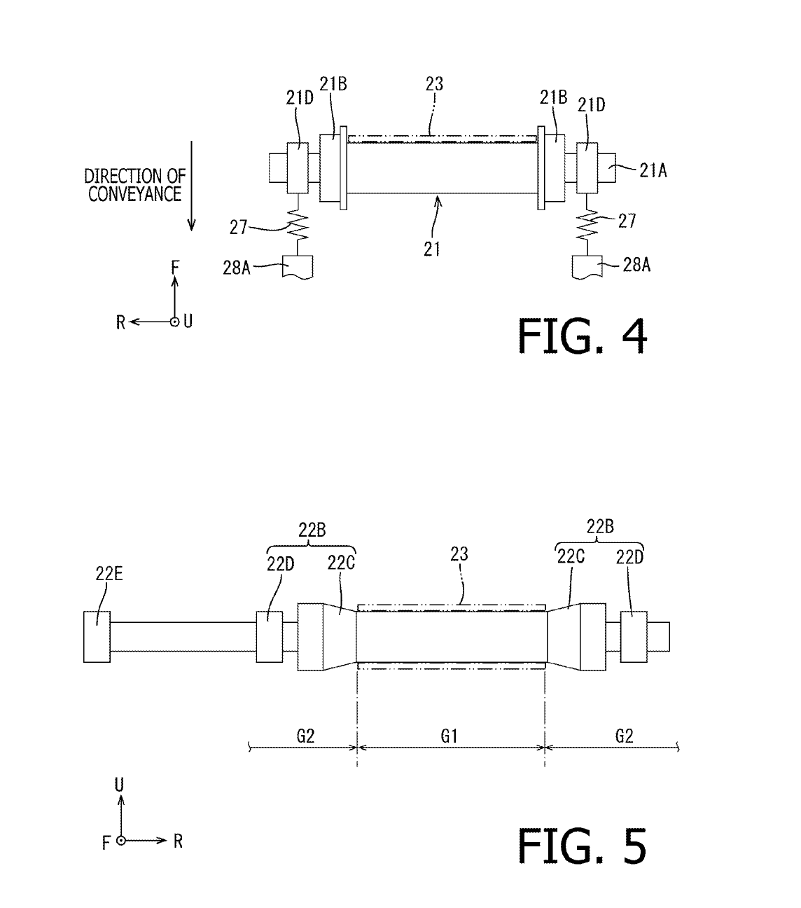

The resilient member 27 includes a pair of resilient members 27, which are supported by the stretched part 28A of the frame 28 and urge the paired bearings 21D in the direction to be away from the driving roller 22. For example, as shown in FIG. 4, an upstream end of each resilient member 27 with regard to the direction of conveyance is fixed to the stretched part 28A, while a downstream end of each resilient member 27 with regard to the direction of conveyance is fixed to the bearing 21D, which is swingably supported by the stretched part 28A. The resilient members 27 provide resilient force, which is directed outward in the direction of conveyance, and thereby the bearings 21D are urged in the direction to be away from the driving roller 22 which are arranged downstream with regard to the direction of conveyance.

As shown in FIG. 3, the driving roller 22 is provided with a flange part 22B. The flange part 22B includes a pair of flange parts 22B, each of which is formed to protrude outward along a radial direction with respect to a part of the driving roller 22 contacting the belt 23. The flange part 22B is arranged in each exposed area G2, which is on the outer side of the belt 23 along the direction of rotation axis. The flange part 22B is, similarly to the flange part 21B on the support roller 22, arranged to face with the cross-sectional edge of the belt 23, which is at a widthwise end along the direction of rotation axis, and restrict the belt 23 from moving in the direction of rotation axis.

Further, the flange part 22B serves to separate the sheet W on the upper outer surface of the belt 23 from the belt 23. The flange part 22B is arranged to protrude outward in the radial direction of the driving roller 22 from the upper outer surface of the belt 23. Therefore, when the sheet W conveyed by the belt 23 reaches the driving roller 22 and contacts the flange part 22B, which protrudes from the upper outer surface of the belt 23, the sheet W is separated from the belt 23 by the contact.

According to the exemplary embodiment, the flange part 22B includes a tapered section 22C, of which diameter is enlarged to be larger as the flange part 22B extends outward along the direction of rotation axis to be away from the widthwise ends of the belt 23, at which the driving roller 22 and the belt 23 contact each other. With the tapered sections 22C, areas for the sheet W to contact the flange parts 22B when the sheet W is being separated from the belt 23 increase to be larger compared to a flange part which does not include the tapered section 22C. Therefore, a force to be applied to the sheet W when the sheet W is being separated from the belt 23 is dispersed so that the sheet W may be prevented from being damaged by the force.

Meanwhile, as shown in FIG. 3, each of the paired bearings 22D for the driving roller 22 is arranged in the exposed area G2, which is provided on each side of the overlapping area G1 with regard to the direction of rotation axis. The bearings 22D are arranged in positions closer to the belt 23 than the axial ends of the transfer rollers 54 with regard to the direction of rotation axis. In particular, the frame 28 includes support parts 28D, which support the bearings 22D at the positions closer to the belt 23 than the axial ends of the transfer rollers 54 with regard to the direction of rotation axis. Therefore, a distance Wz between the paired bearings 22D along the direction of rotation axis is shorter than the dimension Wt of the transfer rollers 54 along the direction of rotation axis. The support parts 28D connect the paired main parts 28C.

The rotation shaft 22A of the driving roller 22 is arranged to extend through the bearing 22D on the left to a vicinity of a leftward end of the frame 28, where a rotating force from a motor (not shown) is input to the rotation shaft 22A through a driving input gear 22E disposed on a leftward end of the rotation shaft 22A of the driving roller 22.

According to the exemplary embodiment described above, the bearings 21D, 22D are provided to rotatably support the support roller 21 and the driving roller 22D respectively. The bearings 21D, 22D each includes paired bearings, which are arranged on both sides of the belt 23 with regard to the direction of rotation axis. The distance between the bearings in each pair with regard to the direction of rotation axis is shorter than the dimension Wt of the transfer rollers 54 along the direction of rotation axis, i.e., a dimension of the image forming area GR along the direction of rotation axis. Therefore, compared to the conventional configuration, in which the distance between the paired bearings along the direction of rotation axis is longer than the dimension of the image forming area GR along the direction of rotation axis, at least a distance between one of the paired bearings and the belt 23 along the direction of rotation axis is shortened; therefore, deformation of the support roller 21 or the driving roller 22 may be restrained.

Accordingly, it is not necessary that, in order to prevent deformation of the support roller 21 or the driving roller 22, the rigidity of the support roller 21 or the driving roller 22 should be enhanced by, for example, thickening the rotation shaft 21A, 22A of the support roller 21 or the driving roller 22. Therefore, a volume of the belt unit 4 may be restrained from being increased.

According to the exemplary embodiment described above, the bearings in the paired bearings 21D, 22D are arranged in the positions closer to the belt 23 than the widthwise ends of the image forming area GR with regard to the direction of rotation axis. Therefore, compared to a configuration, in which the paired bearings are arranged on outer sides of the image forming area GR with regard to the direction of rotation axis, deformation of the support roller 21 and the driving roller 22 may be restrained.

According to the exemplary embodiment described above, the support roller 21 includes the flange part 21B, which protrudes outward in the radial direction; therefore, the sheet W being conveyed may be separated from the belt 23 by the flange part 22B smoothly. The flange part 22B includes the tapered section 22C, which are thickened to have larger diameters as the flange part 22B extend outward to be away from the belt 23 along the direction of rotation axis. Therefore, the force to be applied to the sheet W from the flange part 22B when the sheet W is being separated from the belt 23 is dispersed, and the sheet W may be prevented from being damaged by the contact with the flange parts 22B.

According to the exemplary embodiment described above, the resilient member 27 urges the paired bearings in the bearing 21D, while the resilient member 27 is supported by the frame 28. Therefore, compared to a configuration, in which the resilient member 2 is supported by the frame 28 through other intervening members, the resilient force from the resilient member 27 may be securely transmitted to the bearing 21D.

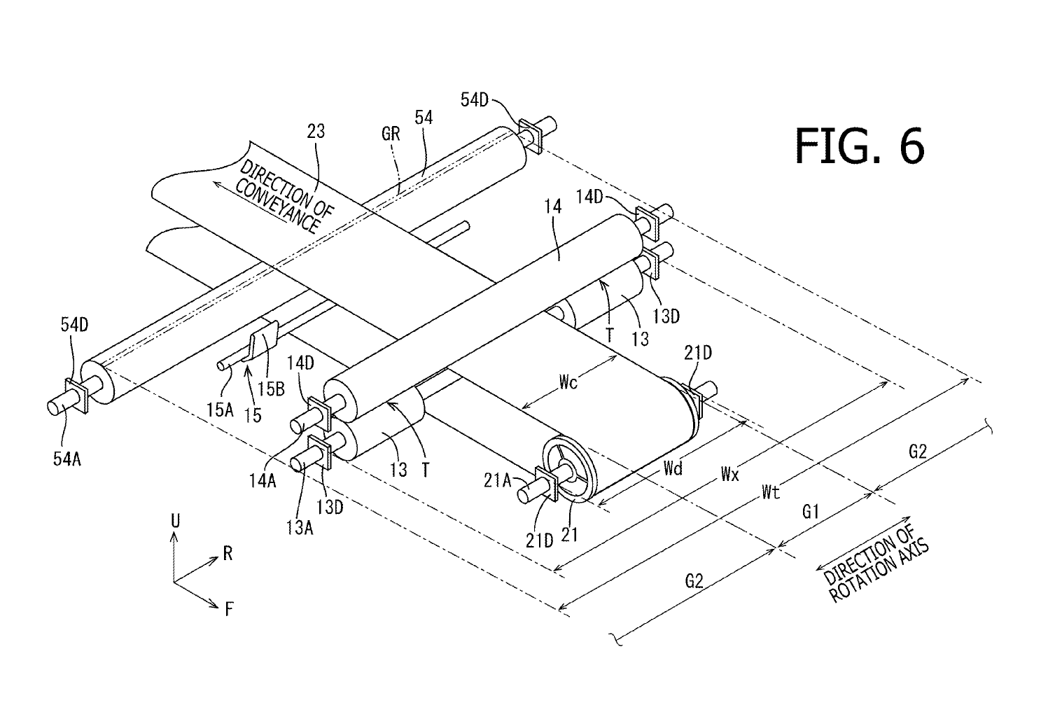

Next, the printer 1 according to another exemplary embodiment will be described herein below with reference to FIG. 6. In the exemplary embodiment, the printer 1 is different from the printer in the previous exemplary embodiment in that a registration unit 7 including the registration roller 13, the pinch roller 14, and the sheet sensor 15 is supported by the frame 28 of the belt unit 4. In the following description, items or structures which are the same as or similar to the items or the structures described in the previous exemplary embodiment will be referred to by the same reference signs, and description of those will be omitted.

As shown in FIG. 6, the registration unit 7 is arranged on a downstream side of the support roller 21 and an upstream side of the transfer rollers 54, i.e., an upstream side of the image forming area GR, with regard to the direction of conveyance. The registration roller 13 has a cylindrical form, which is rotatable about a rotation axis 13A. The registration roller 13 includes two (2) pieces of registration rollers 13, which align along the direction of rotation axis. The two registration roller 13 is arranged on each side of the belt 23 along the direction of rotation axis, that is, in each exposed area G2 located on each side of the overlapping area G1 with regard to the direction of rotation axis.

The registration roller 13 is arranged to locate the rotation axis 13A thereof on a side of a reverse surface of the belt 23, i.e., on an inner side of the belt 23. At the same time, the registration roller 13 is arranged to locate an upper end thereof to protrude upward from the upper outer surface of the belt 23 in a view taken along the direction of axes. The registration roller 13 is made of a material, of which friction coefficient is relatively large, such as rubber, compared to a material of the pinch roller 14.

A bearing 13D for the registration roller 13 includes paired bearings 13D, which are arranged on both sides of the registration roller 13 along the direction of rotation axis, i.e., one of which is arranged on a rightward side of the registration roller 13 on the right, and the other of which is arranged on a leftward side of the registration on the left, along the direction of rotation axis. Each of the paired bearings 13D is arranged in the exposed area G2, which is provided on each side of the overlapping area G1 with regard to the direction of rotation axis. The bearings 13D are arranged in positions closer to the belt 23 than the axial ends of the transfer rollers 54 with regard to the direction of rotation axis. Therefore, a distance Wx between the paired bearings 13D along the direction of rotation axis is shorter than the dimension Wt of the transfer rollers 54 along the direction of rotation axis.

Meanwhile, the pinch roller 14 has a cylindrical form, which is rotatable about a rotation axis 14A. The pinch roller 14 is arranged to oppose to the registration rollers 24 and in a range along the direction of rotation axis between a leftward end of the registration roller 13 on the left and a rightward end of the registration roller 13 on the right. The pinch roller 14 is a roller coated with fluorine, of which friction coefficient is lower than the registration roller 13.

The pinch roller 14 is in an arrangement such that the rotation axis 14A thereof is on the outside of the belt 23, and a lower end thereof contacts the upper ends of the registration roller 13. Therefore, a contact part T, at which the registration roller 13 and the pinch roller 14 contact each other, is in a position upwardly apart from the upper outer surface of the belt 23.

A bearing 14D for the pinch roller 14 includes paired bearings 14D, which are arranged on both sides of the pinch roller 14 along the direction of rotation axis and in straight above positions with respect to the bearings 13D for the registration roller 13. Therefore, a distance between the paired bearings 14D along the direction of rotation axis is equal to the distance Wx between the paired bearings 13D along the direction of rotation axis and is shorter than the dimension Wt of the transfer rollers 54 along the direction of rotation axis.

The sheet sensor 15 is arranged in a position displaced from the belt 23 along the direction of rotation axis and in a position closer to the belt 23 than widthwise ends of the transfer rollers 54 with regard to the direction of axes. The sheet sensor 15 includes an arm 15B, which is rotatable about a rotation axis 15A. The sheet sensor 15 is arranged to locate the rotation axis 15A on the inner side of the belt 23 and to locate an upper end of the arm 15B to protrude upwardly from the upper outer surface of the belt 23.

The sheet sensor 15 is arranged to detect presence of the sheet W in a detectable area, which is between the registration roller 13 and the transfer rollers 54, and outputs signals according to detected presence or absence of the sheet W in the detectable area. For example, the sheet sensor 15 is arranged to locate an upper end of the arm 15B to protrude upward from the upper outer surface of the belt 23. When a leading end of the sheet W being conveyed contacts the arm 15B, the arm 15B pivots, and the sheet sensor 15 sensing the pivot outputs detection signal, which indicates the leading end of the sheet W reaching the detectable area.

A driving force to drive the registration roller 13 is generated in a motor (not shown) and input to the registration roller 13 through an electromagnetic clutch (not shown). The registration roller 13 is rotated by the electromagnetic clutch when the electromagnetic clutch receives a driving instruction from the CPU 71 and is connected with the registration roller 13. On the other hand, the registration roller 24 does not rotate or stops rotating when the electromagnetic clutch receives a stopping instruction from the CPU 71 and is disconnected from the registration roller 24. The pinch roller 14 is rotated along with the rotation of the registration roller 13 and conveys the sheet W to the belt 23 in conjunction with the registration roller 24.

For example, in advance to the leading end of the sheet W reaching the contact part T between the registration roller 13 and the pinch roller 14, the CPU 71 outputs the stopping instruction to the electromagnetic clutch to stop the rotation of the registration roller 13 and the pinch roller 14. Therefore, the sheet W being conveyed by the pickup roller 12 and the feeder rollers 13 is lead to contact the pinch roller 14, of which friction coefficient is smaller than that of the registration roller 13, until the leading end of the sheet W reaches the contact part T, and stops thereat.

While the contact part T is formed longitudinally to extend along the direction of rotation axis, an orientation of the sheet W reaching the contact part T is corrected by the contact with the contact part T to a reference orientation, in which the leading end of the sheet W aligns with the direction of rotation axis. After the leading end of the sheet T reaches the contact part T, the CPU 71 outputs the driving instruction to the electromagnetic clutch at a predetermined timing and manipulates the registration roller 13 and the pinch roller 14 to rotate. Thus, the sheet W aligned with the reference orientation is fed to the belt 23 and passed onto the belt 23.

According to the exemplary embodiment described above, the registration roller 13 is disposed on the outer side of the belt 23 with regard to the direction of rotation axis, while the rotation axis 13A is located on the inner side of the belt 23 with regard to the vertical direction. The pinch roller 14 is arranged to locate the rotation axis thereof on the outer side of the belt 23 and to contact the registration roller 13. According to the above configuration, compared to a configuration, in which the both rotation axes of the registration roller and the pinch roller are located outside the belt 23 with regard to the vertical direction, a distance for the sheet W to travel after being corrected to the reference orientation until the sheet W reaches the belt 23 may be shortened. Therefore, the sheet W may be restrained from reaching the belt 23 in a skewed orientation.

According to the exemplary embodiment described above, the paired bearings 13D for the registration roller 13 is arranged on the both sides of the registration rollers 13 with regard to the direction of rotation axis, and the distance Wx between the paired bearings 13D is smaller than the dimension Wt of the transfer rollers 54 along the direction of rotation axis. Therefore, compared to a configuration, in which the distance Wx between the paired bearings 13D along the direction of rotation axis is longer than the dimension Wt of the transfer rollers 54 along the direction of rotation axis, at least a distance between one of the paired bearings 13D and the registration roller 13 is shortened so that the registration roller 13 may be restrained from being deformed. Similarly, the pinch roller 14 may be restrained from being deformed.

Although examples of carrying out the disclosure have been described, those skilled in the art will appreciate that there are numerous variations and permutations of the image forming apparatus that fall within the spirit and scope of the disclosure as set forth in the appended claims. It is to be understood that the subject matter defined in the appended claims is not necessarily limited to the specific features or act described above. Rather, the specific features and acts described above are disclosed as example forms of implementing the claims.

For example, the image forming apparatus may not necessarily be limited to the multicolor laser printer but may be a printer for forming images in a different image-forming method, such as an inkjet printer with the belt conveyer. In the inkjet printer, for example, an ink ejecting area for an inkjet head may equivalently serve as the image forming area GR. For another example, the image forming apparatus may not necessarily be a multicolor printer but may be a monochrome printer.

For another example, the support roller 21 and the driving roller 22 may not necessarily be the only rollers to strain the belt 23 around, but an additional roller to strain the belt 23 around may be provided in addition to the support roller 21 and the driving roller 22.

For another example, the registration roller 13 may not necessarily be arranged to have the rotation axis 13A thereof to extend continuously through the inner side of the belt 23 along the direction of rotation axis as long as the rotation axis 13A of the registration roller 13 is located on the inner side of the belt 23 when the belt unit 4 is viewed along the direction of rotation axis. Further, the pinch roller 14 may not necessarily be arranged to have the rotation axis 14A thereof to extend continuously through the outer side of the belt 23 along the direction of rotation axis as long as the rotation axis 14A of the pinch roller 14 is located on the outer side of the belt 23 when the belt unit 4 is viewed along the direction of rotation axis.

For another example, rotation of the rollers including the driving roller 22 the registration roller 13 may not necessarily be controlled by the single CPU 71 but may be controlled by a plurality of CPUs, or may be controlled by a dedicated hardware circuit such as the ASIC 75 or by the CPU(s) and hardware circuits.

For another example, the belt 23 may not necessarily be arranged to locate the center thereof along the direction of rotation axis to align with the center of the transfer roller 54 along the direction of rotation axis. For example, the belt 23 may be arranged to locate a leftward end thereof to align with a leftward end of the transfer roller 54. For another example, the belt 23 may not necessarily be a single piece of belt 23 but may include a plurality of pieces of belts 23.

For another example, the flange part 22B in the driving roller 22 may not necessarily have the tapered section 22C but may have, for example, a sphere section (not shown), in which the flange part 22B is formed to have a spherical surface.

What is claimed is:

1. An image forming apparatus, comprising:
a conveyer configured to convey a sheet, comprising:
a first roller;
a second roller; and
a belt strained around the first roller and the second roller and comprising a first surface configured to contact the sheet;
an image forming unit configured to form an image on the sheet being conveyed in an image forming area, the image forming area comprising a width being larger than a width of the belt along a direction of rotation axis of the first roller; and
paired bearings configured to support the first roller rotatably, the paired bearings being arranged on both sides of the belt with regard to the direction of rotation axis, a distance between the paired bearings being shorter than the width of the image forming area.

2. The image forming apparatus according to claim 1,
wherein the image forming area comprises at least a part of a first area and at least a part of a second area, the first area being coincident with the belt, and the second area being displaced from the belt along the direction of rotation axis; and
wherein at least one of the paired bearings is arranged in a position closer to the belt than an end of the image forming area with regard to the direction of rotation axis.

3. The image forming apparatus according to claim 1,
wherein the first roller being arranged on an upstream side of the image forming area with regard to a direction of conveyance comprises an upstream flange, the upstream flange being arranged on an outer side of the belt with regard to the direction of rotation axis and protruding outward along a radial direction of the first roller.

4. The image forming apparatus according to claim 1, further comprising:
a sheet guide configured to form a conveying path for conveying the sheet by the conveyer unit toward the belt in a direction of conveyance, the sheet guide being arranged to face with the belt at a position between the first roller and the image forming area on an upstream side with regard to the direction of conveyance, the first roller being arranged on an upstream side of the image forming area with regard to a direction of conveyance.

5. The image forming apparatus according to claim 1,
wherein the second roller being arranged on a downstream side of the image forming area with regard to a direction of conveyance comprises a downstream flange, the downstream flange being arranged on an outer side of the belt with regard to the direction of rotation axis and protruding outward along a radial direction of the downstream straining roller.

6. The image forming apparatus according to claim 5,
wherein the downstream flange comprises a tapered section, of which diameter is enlarged to be larger as the downstream flange extends outward along the direction of rotation axis to be away from the belt.

7. The image forming apparatus according to claim 1, further comprising:
an urging member configured to urge the first roller in a direction to be away from the second roller, the urging member urging at least one of the paired bearings.

8. The image forming apparatus according to claim 7, further comprising:
a frame configured to support the paired bearings supporting the first roller.

9. The image forming apparatus according to claim 8,
wherein the frame supports the urging member.

10. The image forming apparatus according to claim 1, further comprising:
a registration unit arranged on an upstream side of the image forming area with regard to a direction of conveyance, the registration unit comprising a first-side roller and a second-side roller, the first-side roller being arranged to contact the second-side roller and to locate a rotation axis thereof on a side of the first surface, the second-side roller being arranged on the outer side of the belt with regard to the direction of rotation axis with a rotation axis thereof being located on a side of a second surface of the belt which is a reverse surface of the first surface, the registration unit being configured to manipulate the first-side roller and the second-side roller to align the sheet with a reference orientation and convey the sheet to the belt.

11. The image forming apparatus according to claim 10, further comprising:
paired second-side bearings configured to support the second-side roller rotatably, the paired second-side bearings being arranged on the both sides of the belt with regard to the direction of rotation axes, a distance between the paired second-side bearings being shorter than the width of the image forming area.

12. The image forming apparatus according to claim 1,
wherein the image forming unit comprises:
a photosensitive member arranged on a side of the first surface of the belt, the photosensitive member being configured to carry an image formed in a developer agent; and
a transfer member arranged on a side of a second surface of the belt being a reverse surface of the first surface, the transfer member being configured to transfer the image formed in the developer agent to the sheet in the image forming area.
